(19) United States
(12) Patent Application Publication
(10) Pub. No.: US 2024/0296585 A1
(43) Pub. Date: Sep. 5, 2024

(54) METHOD AND APPARATUS FOR INFERRING POSE OF OBJECT USING 3-DIMENSIONAL MODELING TRANSFORMATION, AND METHOD FOR TRAINING MACHINE LEARNING MODEL

(71) Applicant: Research & Business Foundation SUNGKYUNKWAN UNIVERSITY, Suwon-si (KR)

(72) Inventors: Sukhan LEE, Suwon-si (KR); Yongjun YANG, Suwon-si (KR)

(73) Assignee: Research & Business Foundation SUNGKYUNKWAN UNIVERSITY, Suwon-si (KR)

(21) Appl. No.: 18/591,210

(22) Filed: Feb. 29, 2024

(30) Foreign Application Priority Data
Mar. 2, 2023 (KR) 10-2023-0028005

(51) Int. Cl. G06T 7/73

(52) U.S. Cl. CPC G06T 7/75; G06T 2207/10028

(57) ABSTRACT

There is provided a method for estimating a pose of an object using 3 dimensional modeling transform by transforming a 3D partial point cloud including partial points for the object to a 3D full point cloud for the object.

### TECHNICAL FIELD

The present disclosure relates to a method and an apparatus for estimating the pose of an object through 3 dimensional (3D) modeling transformation, capable of accurately estimating the 6 dimensional (6D) pose of the object by modeling transformation from a 3D partial point cloud of the object to a 3D full point cloud of the object.

This work was partially supported by Institute of Information & communications Technology Planning & Evaluation (IITP) grant funded by Korea government (MSIT; Ministry of Science and ICT) (Development and Validation of an Intelligent Integrated Control Solution for Manufacturing Equipment and Robots Based on 5G Edge Brain, with Logistics Process Verification (No. 2022-0-00067) and Support Project for Cultivating High-Quality ICT Talent (Sungkyunkwan University (No. 2020-0-01821)) and partially supported by National Research Foundation of Korea (NRF) grant funded by Korea government (MSIT) (Neuroscientific Investigation of Deep Learning-Based Visual Sonification Fundamental Technology and Sensory Transfer for the Visually Impaired (No. 2020R1A2C2009568).

### BACKGROUND

Estimation of a 6D pose of an object is crucial for object recognition and modeling in various application fields such as robot manipulation, augmented reality, and autonomous driving. However, it is very difficult to accurately estimate the 6D pose of the object due to various factors such as occlusion by a complex environment around the object or ambiguity in the object's pose.

Existing methods for 6D pose estimation of objects may be categorized into engineering-based, deep learning-based, and hybrid approaches. Engineering-based methods often encounter a problem due to extended processing time for 6D pose estimation of an object. Deep learning-based methods provide the advantage of real-time 6D pose estimation but at the cost of reduced accuracy in the estimated pose. Also, hybrid methods combine deep learning-based object detection and engineering-based pose estimation but may also exhibit a problem due to degradation of real-time performance in the 6D pose estimation of objects.

### SUMMARY

In view of the above, the present disclosure provides a method and an apparatus for estimating the pose of an object through 3D modeling transformation, capable of accurately estimating the 6D pose of the object in real-time by modeling transformation from a 3D partial point cloud of the object to a 3D full point cloud of the object.

In accordance with an aspect of the present disclosure, there is provided a method for estimating a pose of an object, the method comprises: obtaining a 3D partial point cloud including partial points among full points for the object from a 3D camera; estimating a 3D full point cloud for the object from the 3D partial point cloud including the partial points using a pre-trained modeling converter; and estimating a 6D pose of the object from the estimated 3D full point cloud.

The generating the 3D full point cloud of the object may include extracting a first global feature of the object from the 3D partial point cloud using a first autoencoder included in the modeling converter; transforming the first global feature to a second global feature using a latent space association network included in the modeling converter; and reconstructing the 3D partial point cloud including the partial points based on the second global feature using a second autoencoder included in the modeling converter and generating the 3D full point cloud for the object.

The first autoencoder may be trained to receive the 3D partial point cloud including the partial points for the object, extract the first global feature of the object from the 3D partial point cloud including the partial points for the object, reconstruct the 3D partial point cloud including the partial points for the object based on the extracted first global feature, and output the reconstructed 3D partial point cloud including the partial points for the object.

The second autoencoder may be trained to receive the 3D full point cloud for the object, extract the second global feature of the object from the 3D full point cloud, reconstruct the 3D full point cloud based on the extracted first global feature, and output the reconstructed 3D full point cloud for the object.

The latent space association network may be trained to receive the first global feature of the object from the first autoencoder, receive the second global feature of the object from the second autoencoder as label data, transform the first global feature to the second global feature, and output the second global feature transformed from the first global feature.

The 3D full point cloud may include a 3D camera-based first coordinates and an object-based second coordinates matched to the 3D camera-based first coordinates.

Herein, the estimating the 6D pose of the object may include estimating the 6D pose of the object using a transformation matrix to minimize an error between the first coordinates and the second coordinates.

The 6D pose may include rotation angles around three directions of the object and translation distances along the three directions of the object.

In accordance with another aspect of the present disclosure, there is provided an apparatus for estimating a pose of an object, the apparatus comprises: a memory configured to store a pose estimation program for estimating a pose of an object; and a processor configured to execute the pose estimation program stored in the memory, wherein the pose estimation program, when executed by the processor, cause the processor to: obtain a 3 dimensional (3D) partial point cloud including partial points among full points for the object from a 3D camera; estimate a 3D full point cloud for the object from the 3D partial point cloud including the partial points using a pre-trained modeling converter; and estimate a 6 dimensional (6D) pose of the object from the estimated 3D full point cloud.

The pre-trained modeling converter may include a first autoencoder and a second autoencoder connected with a latent space association network.

The processor may be configured to extract a first global feature of the object from the 3D partial point cloud using a first autoencoder included in the modeling converter, transform the first global feature to a second global feature using the latent space association network included in the modeling converter, reconstruct the 3D partial point cloud including the partial points based on the second global feature using a second autoencoder included in the modeling converter, and generate the 3D full point cloud for the object.

Herein, the first autoencoder may be trained to receive the 3D partial point cloud including the partial points for the object, extract the first global feature of the object from the 3D partial point cloud including the partial points for the object, reconstruct the 3D partial point cloud including the partial points for the object based on the extracted first global feature, and output the reconstructed 3D partial point cloud including the partial points for the object.

Herein, the second autoencoder may be trained to receive the 3D full point cloud for the object, extract the second global feature of the object from the 3D full point cloud, reconstruct the 3D full point cloud based on the extracted first global feature, and output the reconstructed 3D full point cloud for the object.

Herein, the latent space association network may be trained to receive the first global feature of the object from the first autoencoder, receive the second global feature of the object from the second autoencoder as label data, transform the first global feature to the second global feature, and output the second global feature transformed from the first global feature.

The 3D full point cloud may include a 3D camera-based first coordinates and an object-based second coordinates matched to the 3D camera-based first coordinates, and the processor may be configured to estimate the 6D pose of the object using a transformation matrix to minimize an error between the first coordinates and the second coordinates.

Herein, the 6D pose may include rotation angles around three directions of the object and translation distances along the three directions of the object.

In accordance with another aspect of the present disclosure, there is provided a method for training a machine learning model, the method comprises: preparing training data including training input data having object class information for a predetermined object and a 3D partial point cloud including a partial points, and training label data having a 3D full point cloud including full points for the object; and providing the training input data to the machine learning model and training the machine learning model to output the training label data.

The preparing the training data may include generating a 3D partial point cloud by randomly sampling a predetermined number of points from among a plurality of points included in the 3D full point cloud of the object.

The machine learning model may include a first autoencoder and a second autoencoder, and a latent space association network connected with the first autoencoder and the second autoencoder. The training the machine learning model may include extracting a first global feature of the object from the 3D partial point cloud using a first autoencoder included in the machine learning model, transforming the first global feature to a second global feature using the latent space association network included in the machine learning model, reconstructing the 3D partial point cloud including the partial points based on the second global feature using a second autoencoder included in the machine learning model, and generating the 3D full point cloud for the object.

The training the machine learning model may include inputting the 3D partial point cloud including the partial points for the object to the first autoencoder, extracting the first global feature of the object from the 3D partial point cloud including the partial points for the object, reconstructing the 3D partial point cloud including the partial points for the object based on the extracted first global feature, and outputting the reconstructed 3D partial point cloud including the partial points for the object.

The training the machine learning model may include inputting the 3D full point cloud for the object to the second autoencoder, extracting the second global feature of the object from the 3D full point cloud, reconstructing the 3D full point cloud based on the extracted first global feature, and training the machine learning model to output the reconstructed 3D full point cloud for the object.

The training the machine learning model includes inputting the first global feature of the object output from the first autoencoder to the latent space association network, receiving the second global feature of the object from the second autoencoder as label data, transforming the first global feature to the second global feature, and output the second global feature transformed from the first global feature.

A method for estimating the pose of an object according to the present disclosure may perform in real-time modeling transformation that generates a 3D full point cloud of the object from a 3D partial point cloud due to partial occlusion of the object.

Accordingly, the present disclosure may accurately estimate the 6D pose of an object, namely, the position and orientation of the object, in real-time, from a 3D full point cloud obtained from modeling transformation.

### BRIEF DESCRIPTION OF THE DRAWINGS

FIG. 1 is a block diagram illustrating an apparatus for estimating the pose of an object according to an embodiment of the present disclosure.

FIG. 2 conceptually illustrates the functions of the pose estimation program of FIG. 1.

FIG. 3 is a block diagram illustrating the modeling converter of FIG. 2.

FIG. 4 illustrates an embodiment of a method for training the first autoencoder of FIG. 3.

FIG. 5 illustrates an embodiment of a method for training the second autoencoder of FIG. 3.

FIG. 6 illustrates an embodiment of a method for training the latent space association network of FIG. 3.

FIG. 7 is a flow diagram illustrating a method for estimating the pose of an object according to an embodiment of the present disclosure.

FIG. 8 is a flow diagram illustrating in detail the procedure of generating a 3D full point cloud of an object of FIG. 7.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

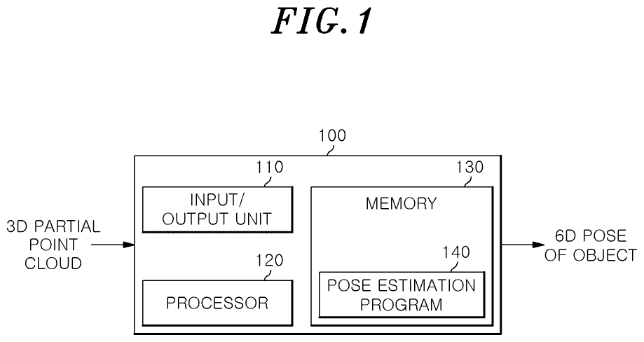

Referring to FIG. 1, the apparatus 100 for estimating the pose of an object according to the present embodiment may include an input/output unit 110, a processor 120, and a memory 130.

The input/output unit 110 may receive a 3D image of one or more objects from an external device, for example, a 3D camera (not shown) and provide the received 3D image to the processor 120. Here, the 3D image received by the input/output unit 110 may be a partial point cloud obtained from occlusion of a portion of the object.

Also, the input/output unit 110 may transmit the estimated pose of the object to an external device, for example, an object management server (not shown) based on the 3D partial point cloud. Here, the processor 120 may estimate the 6D pose of the object, where the 6D pose may include information on the 3D position and orientation of the object.

The processor 120 may generate a 3D full point cloud of the object based on the 3D partial point cloud of the object provided through the input/output unit 110 and estimate the 6D pose of the object based on the generated 3D full point cloud.

The memory 130 may store the pose estimation program 140 and information required for its execution. The pose estimation program 140 may be software that includes instructions for estimating the 6D pose of an object from a previously received 3D partial point cloud of the object.

Accordingly, the processor 120 may execute the pose estimation program 140 stored in the memory 130 and estimate the 6D pose of the object using the executed program from the 3D partial point cloud of the object received through the input/output unit 110.

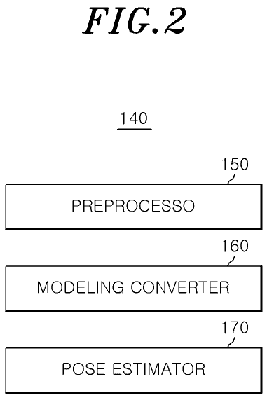

FIG. 2 conceptually illustrates the functions of the pose estimation program of FIG. 1.

Referring to FIG. 2, the pose estimation program 140 of the present embodiment may include a preprocessor 150, a modeling converter 160, and a pose estimator 170.

The preprocessor 150, modeling converter 160, and pose estimator 170 shown in FIG. 2 have been conceptually divided for the purpose of describing the functions of the pose estimation program 140, but the present disclosure is not limited to the specific structure.

For example, the functions of the preprocessor 150, modeling converter 160, and pose estimator 170 of the pose estimation program 140 may be merged or separated according to an embodiment of the present disclosure, or the functions may be implemented using a series of instructions included in one program.

The preprocessor 150 may perform preprocessing to remove noise from the 3D partial point cloud provided by the input/output unit 110.

Also, according to the embodiment, the preprocessor 150 may extract a partial point cloud of at least one object, for which a 6D pose is to be estimated by the pose estimator 170 described later, from among noise-removed 3D partial point clouds.

For example, when a 3D partial point cloud provided through the input/output unit 110 is a partial point cloud for a plurality of objects, the preprocessor 150 may extract a partial point cloud of at least one object designated for pose estimation from among the plurality of objects and output the extracted partial point cloud.

The modeling converter 160 may perform modeling transformation from a 3D partial point cloud provided through the preprocessor 150 to a 3D full point cloud of the object and output the transformed full point cloud. The modeling converter 160 may include one or more neural network models pre-trained to perform modeling transformation.

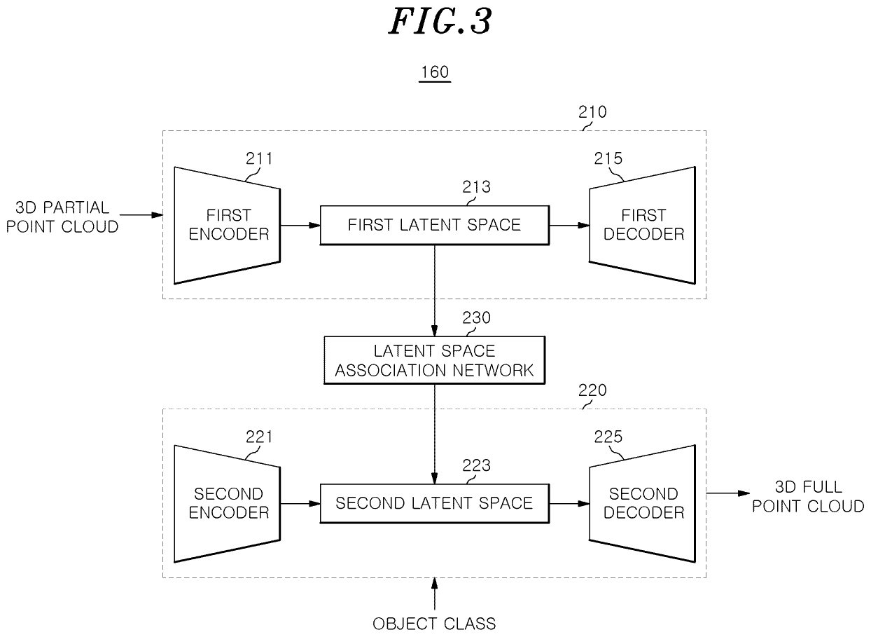

FIG. 3 is a block diagram illustrating the modeling converter of FIG. 2.

Referring to FIG. 3, the modeling converter 160 of the present embodiment may include a first autoencoder 210, a second autoencoder 220, and a latent space association network (LSAN).

The first autoencoder 210 may include a first encoder 211 and a first decoder 215, and the second autoencoder 220 may include a second encoder 221 and a second decoder 225.

Here, the first encoder 211 and the second encoder 221 may have substantially the same configuration and may be, for example, KC-Net encoders. Also, the first decoder 215 and the second decoder 225 may have substantially the same configuration and, for example, may be bias induced decoders (BIDs).

The first autoencoder 210 may receive a 3D partial point cloud from the preprocessor 150 and extract one or more first global features by transforming the 3D partial point cloud to a first latent space 213 through the first encoder 211.

The second autoencoder 220 may receive one or more second global features through a latent space association network 230, which will be described later; based on the one or more second global features, the second autoencoder 220 may reconstruct the 3D partial point cloud to a 3D full point cloud and output the 3D full point cloud through the second decoder 225.

At this time, the second autoencoder 220 may concatenate the type information (object class) of objects received from the outside and one or more second global features and provide the concatenated information as input to the second decoder 225.

The latent space association network 230 may define a cross-relationship between the first autoencoder 210 and the second autoencoder 220. This latent space association network 230 may transform the first latent space 213 of the first autoencoder 210 into the second latent space 223 of the second autoencoder 220 and thus transform one or more first global features of the first latent space 213 into one or more second global features of the second latent space 223. Here, the second global feature may be a global feature for the 3D full point cloud corresponding to the 3D partial point cloud of the object.

The first autoencoder 210, the second autoencoder 220, and the latent space association network 230 of the modeling converter 160 described above may be a neural network model trained using predetermined learning data. In what follows, a method for training the first autoencoder 210, the second autoencoder 220, and the latent space association network 230 will be described in detail with reference to the drawings.

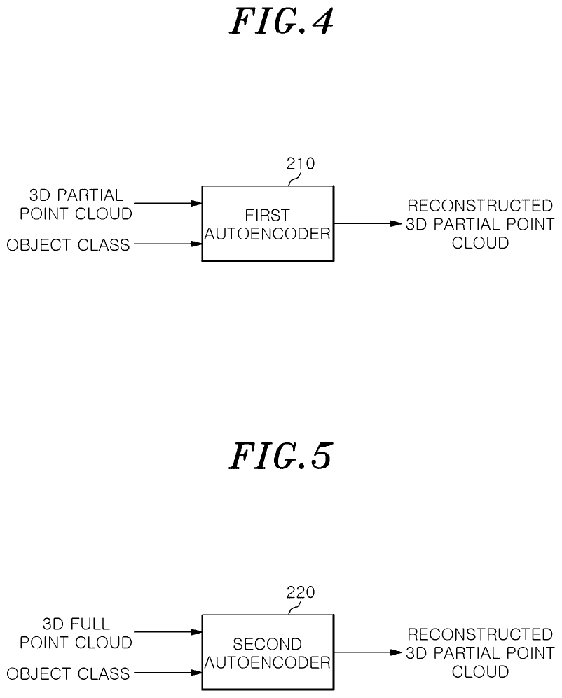

FIG. 4 illustrates an embodiment of a method for training the first autoencoder of FIG. 3.

Referring to FIG. 4, the first autoencoder 210 of the present embodiment may be trained so that when type information (object class) and a 3D partial point cloud of an object are received, the first autoencoder 210 extracts one or more first global features by transforming the 3D partial point cloud into the first latent space 213 using the first encoder 211 and reconstructs the 3D partial point cloud based on the one or more first global features using the first decoder 215 and outputs the reconstructed 3D partial point cloud.

The first autoencoder 210 may repeatedly perform the training of generating and outputting a reconstructed 3D partial point cloud from an input 3D partial point cloud while adjusting internal parameters to minimize the error between the input 3D partial point cloud and the reconstructed 3D partial point cloud.

Here, the 3D partial point cloud used for training the first autoencoder 210 may be learning data generated using a simulator (not shown), where the learning data are generated by randomly sampling a predetermined number of points from among a plurality of points included in the 3D full point cloud of a predetermined object.

For example, given that the 3D full point cloud contains approximately 2,048 points, a 3D partial point cloud containing approximately 512 points may be generated by randomly sampling the points of the 3D full point cloud.

Accordingly, the first encoder 211 of the first autoencoder 210 may transform the 3D partial point cloud containing 512 points into the first latent space 213 and extract approximately 512 first global features for the 3D partial point cloud. Here, the first global feature may have a vector form.

Also, the first decoder 215 of the first autoencoder 210 may generate a reconstructed 3D partial point cloud consisting of 512 points based on the 512 first global features.

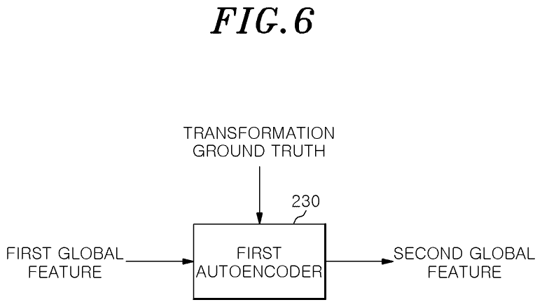

FIG. 5 illustrates an embodiment of a method for training the second autoencoder of FIG. 3.

Referring to FIG. 5, the second autoencoder 220 of the present embodiment may be trained so that when type information (object class) and a 3D full point cloud of an object are received, the second autoencoder 220 extracts one or more second global features by transforming the 3D full point cloud into the second latent space 223 using the second encoder 221 and reconstructs the 3D full point cloud based on the one or more second global features using the second decoder 225 and outputs the reconstructed 3D full point cloud.

The second autoencoder 220 may repeatedly perform the training of generating and outputting a reconstructed 3D full point cloud from an input 3D partial point cloud while adjusting internal parameters to minimize the error between the input 3D full point cloud and the reconstructed 3D full point cloud.

Here, the 3D full point cloud used for training the second autoencoder 220 is learning data generated using a simulator (not shown), where the learning data may be generated by sampling a plurality of points from among the 3D full point cloud of a predetermined object.

At this time, the plurality of points of the 3D full point cloud may include first coordinates defined based on the frame of a 3D camera and second coordinates defined based on the frame of an object corresponding to the first coordinates. Here, the first coordinates and the second coordinates may be matched to each other one-to-one, and the first coordinates and the second coordinates may be concatenated to represent the coordinates of individual points.

For example, if the first coordinates of an object for one point in a 3D full point cloud are (x1, y1, z1) and the second coordinate are (x2, y2, z2), the one point may be expressed by the 6D coordinates of (x1, x2, y1, y2, z1, z2) by concatenating the first and second coordinates.

Also, if the 3D full point cloud contains approximately 2,048 points, the second encoder 221 of the second autoencoder 220 may transform the 3D full point cloud into the second latent space 223 and extract the second global features consisting of approximately 512 vectors from the 3D full point cloud.

Also, the second decoder 225 may generate a reconstructed 3D full point cloud consisting of 2,048 points based on 512 second global features.

FIG. 6 illustrates an embodiment of a method for training the latent space association network of FIG. 3.

Referring to FIG. 6, the latent space association network 230 of the present embodiment may be trained so that when a first global feature of an object extracted from the first autoencoder 210 is received, and a transformation ground truth data, namely, a second global feature of the object extracted from the second autoencoder 220 is received as label data, the latent space association network 230 transforms the first global feature to the second global feature.

The latent space association network 230 may repeatedly perform the training of transforming the first global feature to the second global feature while adjusting internal parameters to minimize the error, for example, mean squared error (MSE) between the second global feature output from the second autoencoder 220 and the transformation ground truth data input as the label data.

Here, a 3D image of the same object may be input to each of the first autoencoder 210 and the second autoencoder 220. Accordingly, the first global feature input from the first autoencoder 210 to the latent space association network 230 and the second global feature input from the second autoencoder 220 to the latent space association network 230 may be global features extracted from the same object.

Meanwhile, the first autoencoder 210, the second autoencoder 220, and latent space association network 230 described above may be trained sequentially. For example, the modeling converter 160 of the present embodiment may proceed with training in the order of the first autoencoder 210, the second autoencoder 220, and the latent space association network 230. At this time, the first autoencoder 210 and the second autoencoder 220 may be trained using a 3D image generated through simulation of the same object.

Referring again to FIG. 2, the pose estimator 170 may estimate the pose of the object, namely, the 6D pose of the object, based on the 3D full point cloud of the object output from the modeling converter 160.

For example, the pose estimator 170 may calculate the optimal transformation matrix between a point cloud based on the 3D camera frame output from the modeling converter 160 and a point cloud based on the object frame to estimate the 6D pose of the object.

Here, the 6D pose to be estimated is a transformation matrix with the smallest error in terms of least square error of the two point clouds, namely, the camera frame-based point cloud and the object frame-based point cloud, and the transformation matrix may be composed of a rotation matrix and a translation vector.

Also, the process of finding the optimal transformation matrix in the pose estimator 170 may include at least one of a process of finding the center point between two point clouds, a process of finding the optimal rotation matrix after moving the two point clouds to the origin of the coordinate system, or a process of calculating the translation distance between the two point clouds.

Here, the center point between the two point clouds may be determined through a process of calculating the average values of x, y, and z coordinates of the points constituting the point clouds. Also, the optimal rotation matrix of the two point clouds may be determined through a process of moving the two point clouds to the origin of the coordinate system and calculating a rotation matrix that rotates the point clouds from the camera frame to the object frame using the SVD methods. Also, the translation distance between the two point clouds may be determined by calculating a 3D Euclidean distance between two points obtained by transforming the center point of the point cloud in the object frame and the center point of the point cloud in the camera frame through a rotation transform.

Here, the 3D full point cloud may include first coordinates based on the 3D camera frame and second coordinates based on the corresponding object frame.

Accordingly, the pose estimator 170 may estimate the 6D pose of the object using a transformation matrix that minimizes the error, namely, distance between the first and second coordinates of the 3D full point cloud. At this time, the 6D pose of the object may include the rotation angles around the three axes of the object, namely, X, Y, and Z axes and the translation distances along the three directions.

As described above, even if a 3D partial point cloud of an occluded object is input, the object pose estimator 100 of the present embodiment may perform in real-time modeling transformation that generates a 3D full point cloud of the object from the 3D partial point cloud using the pre-trained modeling converter 160.

Also, the object pose estimator 100 of the present embodiment may accurately estimate the 6D pose of the object in real-time, namely, the position and orientation of the object from the 3D full point cloud obtained from the modeling transformation.

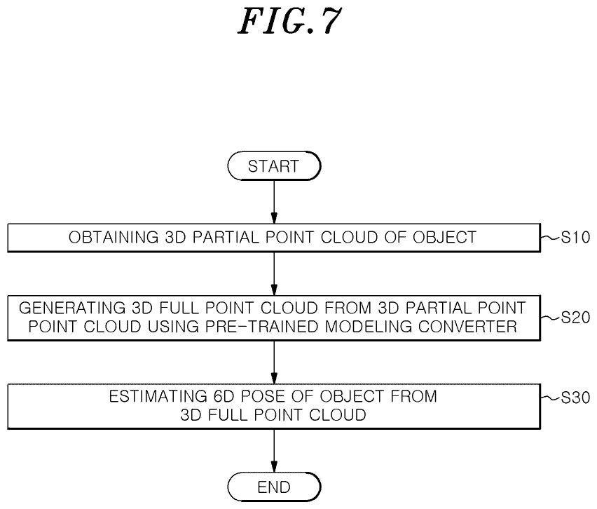

FIG. 7 is a flow diagram illustrating a method for estimating the pose of an object according to an embodiment of the present disclosure.

Referring to FIG. 7, the object pose estimator 100 may obtain a 3D image of the object, for example, a 3D partial point cloud of the object of which a portion is occluded, from an external 3D camera (not shown) through the input/output unit 110 S10.

The processor 120 of the object pose estimator 100 may execute the pose estimation program 140 stored in the memory 130 and estimate the 6D pose of the object from a previously obtained 3D partial point cloud of the object using the pose estimation program 140.

First, the preprocessor 150 may remove noise by pre-processing the 3D partial point cloud and output a 3D partial point cloud from which noise has been removed.

Next, the modeling converter 160 may generate a 3D full point cloud for the object from the 3D partial point cloud S20.

Here, the modeling converter 160 may include the first autoencoder 210, the second autoencoder 220, and the latent space association network 230 that associates a latent space between the first autoencoder 210 and the second autoencoder 220; they may be pre-trained to generate a 3D full point cloud from a 3D partial point cloud.

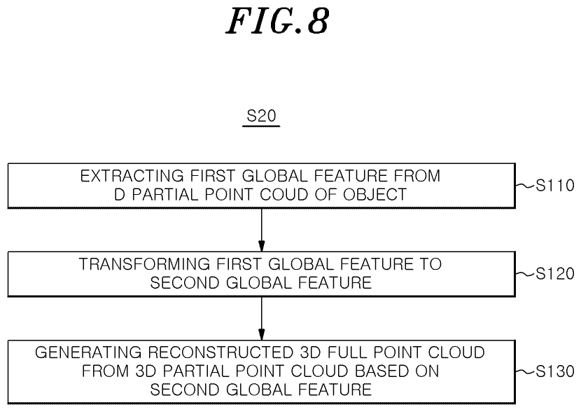

FIG. 8 is a flow diagram illustrating in detail the procedure of generating a 3D full point cloud of an object of FIG. 7.

Referring to FIG. 8, the first autoencoder 210 may receive a 3D partial point cloud and extract one or more first global features for the object by transforming the received 3D partial point cloud to the first latent space 213 S110.

Subsequently, the latent space association network 230 may transform the first latent space 213 of the first autoencoder 210 into the second latent space 223 of the second autoencoder 220 and accordingly, transform one or more first global features to one or more corresponding second global features S120.

Next, the second autoencoder 220 may reconstruct the 3D partial point cloud into a 3D full image based on one or more second global features and output the reconstructed 3D full point cloud S130.

Referring again to FIG. 7, the pose estimator 170 may estimate the 6D pose of the object from the 3D full point cloud of the object output from the modeling converter 160 and output the estimated 6D pose S30.

As described above, the 3D full point cloud of the object may include the first coordinates of the object based on the 3D camera frame and the corresponding second coordinates of the object based on the object frame.

Therefore, the pose estimator 170 may estimate the 6D pose of the object using a transformation matrix that minimizes the error between the first coordinates and the second coordinates of the 3D full point cloud. At this time, the 6D pose of the object may include the rotation angle around the three axes of the object, namely, X, Y, and Z axes and the translation distance along the three directions.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for estimating a pose of an object, the method comprising:
obtaining a 3 dimensional (3D) partial point cloud including partial points among full points for the object from a 3D camera;
estimating a 3D full point cloud for the object from the 3D partial point cloud including the partial points using a pre-trained modeling converter; and
estimating a 6 dimensional (6D) pose of the object from the estimated 3D full point cloud.

2. The method of claim 1, wherein the generating the 3D full point cloud of the object includes:
extracting a first global feature of the object from the 3D partial point cloud using a first autoencoder included in the modeling converter;
transforming the first global feature to a second global feature using a latent space association network included in the modeling converter; and
generating the 3D full point cloud for the object by reconstructing the 3D partial point cloud based on the second global feature using a second autoencoder included in the modeling converter.

3. The method of claim 2, wherein the first autoencoder is trained to receive the 3D partial point cloud including the partial points for the object, extract the first global feature of the object from the 3D partial point cloud including the partial points for the object, reconstruct the 3D partial point cloud including the partial points for the object based on the extracted first global feature, and output the reconstructed 3D partial point cloud including the partial points for the object.

4. The method of claim 2, wherein the second autoencoder is trained to receive the 3D full point cloud for the object, extract the second global feature of the object from the 3D full point cloud, reconstruct the 3D full point cloud based on the extracted first global feature, and output the reconstructed 3D full point cloud for the object.

5. The method of claim 2, wherein the latent space association network is trained to receive the first global feature of the object from the first autoencoder, receive the second global feature of the object from the second autoencoder as label data, transform the first global feature to the second global feature, and output the second global feature transformed from the first global feature.

6. The method of claim 1, wherein the 3D full point cloud includes a 3D camera-based first coordinates and an object-based second coordinates matched to the 3D camera-based first coordinates,
wherein the estimating the 6D pose of the object includes estimating the 6D pose of the object using a transformation matrix to minimize an error between the first coordinates and the second coordinates.

7. The method of claim 6, wherein the 6D pose includes rotation angles around three directions of the object and translation distances along the three directions of the object.

8. A apparatus for estimating a pose of an object, the apparatus comprising:
a memory configured to store a pose estimation program for estimating a pose of an object; and
a processor configured to execute the pose estimation program stored in the memory, wherein the pose estimation program, when executed by the processor, cause the processor to:
obtain a 3 dimensional (3D) partial point cloud including partial points among full points for the object from a 3D camera;
estimate a 6D full point cloud for the object from the 3D partial point cloud including the partial points using a pre-trained modeling converter; and
estimate a 6 dimensional (6D) pose of the object from the estimated 6D full point cloud.

9. The apparatus of claim 8, wherein the pre-trained modeling converter includes a first autoencoder and a second autoencoder connected with a latent space association network, and
wherein the processor is configured to extract a first global feature of the object from the 3D partial point cloud using a first autoencoder included in the modeling converter, transform the first global feature to a second global feature using the latent space association network included in the modeling converter, generate the 3D full point cloud for the object by reconstructing the 3D partial point cloud based on the second global feature using a second autoencoder included in the modeling converter.

10. The apparatus of claim 9, wherein the first autoencoder is trained to receive the 3D partial point cloud including the partial points for the object, extract the first global feature of the object from the 3D partial point cloud including the partial points for the object, reconstruct the 3D partial point cloud including the partial points for the object based on the extracted first global feature, and output the reconstructed 3D partial point cloud including the partial points for the object.

11. The apparatus of claim 9, wherein the second autoencoder is trained to receive the 3D full point cloud for the object, extract the second global feature of the object from the 3D full point cloud, reconstruct the 3D full point cloud based on the extracted first global feature, and output the reconstructed 3D full point cloud for the object.

12. The apparatus of claim 9, wherein the latent space association network is trained to receive the first global feature of the object from the first autoencoder, receive the second global feature of the object from the second autoencoder as label data, transform the first global feature to the second global feature, and output the second global feature transformed from the first global feature.

13. The apparatus of claim 9, wherein the 3D full point cloud includes a 3D camera-based first coordinates and an object-based second coordinates matched to the 3D camera-based first coordinates,
wherein the processor is configured to estimate the 6D pose of the object using a transformation matrix to minimize an error between the first coordinates and the second coordinates.

14. The apparatus of claim 13, wherein the 6D pose includes rotation angles around three directions of the object and translation distances along the three directions of the object.

15. A method for training a machine learning model, the method comprising:
preparing training data including training input data having object class information for a predetermined object and a 3D partial point cloud including a partial points, and training label data having a 3D full point cloud including full points for the object; and
providing the training input data to the machine learning model and training the machine learning model to output the training label data.

16. The method of claim 15, the preparing the training data includes generating a 3D partial point cloud by randomly sampling a predetermined number of points from among a plurality of points included in the 3D full point cloud of the object.

17. The method of claim 16, wherein the machine learning model includes a first autoencoder and a second autoencoder, and a latent space association network connected with the first autoencoder and the second autoencoder, and
wherein the training the machine learning model includes extracting a first global feature of the object from the 3D partial point cloud using a first autoencoder included in the machine learning model, transforming the first global feature to a second global feature using the latent space association network included in the machine learning model, generating the 3D full point cloud for the object by reconstructing the 3D partial point cloud based on the second global feature using a second autoencoder included in the machine learning model.

18. The method of claim 17, wherein the training the machine learning model includes inputting the 3D partial point cloud including the partial points for the object to the first autoencoder, extracting the first global feature of the object from the 3D partial point cloud including the partial points for the object, reconstructing the 3D partial point cloud including the partial points for the object based on the extracted first global feature, and outputting the reconstructed 3D partial point cloud including the partial points for the object.

19. The method of claim 17, wherein the training the machine learning model includes inputting the 3D full point cloud for the object to the second autoencoder, extracting the second global feature of the object from the 3D full point cloud, reconstructing the 3D full point cloud based on the extracted first global feature, and training the machine learning model to output the reconstructed 3D full point cloud for the object.

20. The method of claim 17, wherein the training the machine learning model includes inputting the first global feature of the object output from the first autoencoder to the latent space association network, receiving the second global feature of the object from the second autoencoder as label data, transforming the first global feature to the second global feature, and output the second global feature transformed from the first global feature.
